(19) United States
(12) Patent Application Publication
(10) Pub. No.: US 2014/0068173 A1
(43) Pub. Date: Mar. 6, 2014

(54) CONTENT ADDRESSABLE MEMORY SCHEDULING

(71) Applicant: Laurence H. COOKE, Los Gatos, CA (US)

(72) Inventor: Laurence H. COOKE, Los Gatos, CA (US)

(21) Appl. No.: 13/596,795

(22) Filed: Aug. 28, 2012

(51) Int. Cl. G06F 12/00

(52) U.S. Cl. 711/108; 711/E12.001

(57) ABSTRACT

A digital system may utilize a serial content-addressable memory (CAM), capable of performing greater than, less than and/or equal comparisons between its contents and serially inputted data records according to a type of each data record, to select software routine addresses and associated parameters. The system may also include a scheduler, which may select one or more available processors to execute the software routines on the data records.

### FIELD OF THE INVENTION

Embodiments of the present invention may pertain to content-addressable memory processing systems that may be used to generate metadata from streaming data associated with data storage systems.

### BACKGROUND OF THE INVENTION

Traditionally, content-addressable memories (CAMs) have been used in computer caches, particularly instruction caches as described, e.g., in U.S. Pat. No. 5,819,308 granted Oct. 6, 1998 to Tien et al., CAMs have also been used in virtual address translation or network routers, and occasionally as a hardware assist to replace hashing or searching within a software program as described, e.g., in U.S. Pat. No. 7,260,674 granted Aug. 21, 2007 to Mukherjee, or to avoid conflicts when ordering instruction execution, such as described in U.S. Pat. No. 6,101,597 granted Aug. 8, 2000 to Colwell et al. However, historically, CAMs have not been used in scheduling processes, selected by the CAM, to generate metadata with respect to streaming input data.

Traditional CAMs may be particularly suited to parallel input data. By comparison, serial CAMs may be made more compact, which may allow for more CAM storage. A number of examples of serial content addressable memories (CAMs) exist, including U.S. Pat. No. 7,369,422 granted May 6, 2008 to Cooke; and 8,085,567 granted Dec. 27, 2011, also to Cooke; and U.S. patent application Ser. No. 12/166,960, filed on Jul. 2, 2008, also to Cooke, all of which are incorporated herein by reference.

The cloud has exploded the demand for storage well past terabytes and petabytes up to zettabytes and yottabytes. This has shifted the management of large storage systems from relational databases to metadata-indexed serially streamed log files. These “big data” storage systems tend to initially store the data in chronological order, with indices, into serial log storage using various forms of metadata, as may be required to access the original data. This is typically done by large sets of servers, which analyze the data and update the metadata prior to ultimately storing the data in permanent nonvolatile storage. This processing requires expensive computing systems, and may be slowed by the analysis, which may require complex comparisons between multiple tags in the data records to select among large numbers of possible operations to be performed on the associated metadata. The selection may also be among large numbers of independent streams of data whose only association may be the chronological order in which they may be stored. The processing of any given record may include generating addresses, indices, and intermediate data, such as counts and incremental checksums of the actual data. It may thus be desirable to be able to provide an inexpensive way to quickly schedule the proper computation required to generate the necessary metadata.

### SUMMARY OF EMBODIMENTS OF THE INVENTION

Various embodiments of the invention may involve the use of a CAM, which may, in particular, be a serial CAM, to compare multiple data record tags with a large number of preexisting record types, subsequently scheduling and executing one or more processes using the existing data record to either update the CAM or generate appropriate metadata for the data record, where the scheduled process may be a single operation applied to the CAM or a software routine executed on an available processor.

In one embodiment, a serial CAM may perform greater than or less than and equal, as well as just equal matches. In another embodiment, a serial CAM may be controlled by a control unit containing a stored set of control values based on the format of the records being processed. A specific set of stored control values may be selected from a number of different control values depending on the number, size, and/or type of tag comparisons.

In another embodiment, a method for processing data records may include the following:
a. Inputting a data record's type field to select a schema control process for processing the data record,
b. Comparing the data record's tag fields with the contents of a serial CAM according to the selected schema control process,
c. Writing result data selected by the serial CAM comparisons into a memory, which may be a first-in-first-out (FIFO) memory,
d. Upon completion of inputting the data record, selecting the result data from the memory, and
e. Performing the following: selecting a schema control process for updating the CAM, and/or issuing to a selected available processor for processing a packet including the result data obtained from the memory and/or at least a portion of the data record.

The result data may be comprised of the address of the software routine used for processing the data record and its associated parameters.

### BRIEF DESCRIPTION OF THE DRAWINGS

Embodiments of the invention will now be described in connection with the attached drawings, in which:

FIG. 1 is a diagram of a content addressable processing system according to an embodiment of the invention,

FIG. 2 is a simplified diagram of a data record that may be applicable to an embodiment of the invention,

FIG. 3 is a more detailed diagram of an embodiment of the scheduler in FIG. 1, and

FIG. 4 is a diagram of a slice of a serial CAM according to an embodiment of the invention.

### DESCRIPTION OF VARIOUS EMBODIMENTS

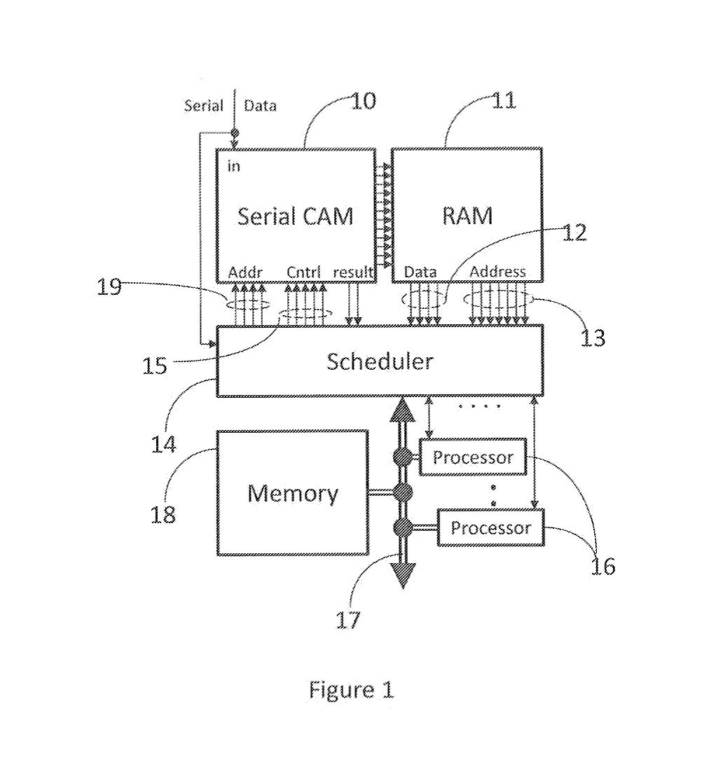

Various embodiments of the present invention is now described with reference to FIGS. 1-4, it being appreciated that the figures illustrate various aspects of the subject matter and may not be to scale or to measure.

An embodiment of the present invention may involve using a serial CAM to compare multiple data record tags with a large number of preexisting record types, subsequently scheduling and executing one or more processes on the existing data record to either update the CAM or generate appropriate metadata for the data record, where the scheduled process may be a single operation applied to the CAM or a software routine executed on an available processor.

Reference is now made to FIG. 1, a diagram of a content addressable processing system according to an embodiment of the invention. In this embodiment, a serial CAM 10 may be coupled to a RAM 11, which may contain parameters 12 and addresses 13 of software routines that may be processed by a scheduler 14, which may either send CAM control signals 15 and circular addresses 19 to update the serial CAM's 10 comparison operation, or schedule a processor 16 to process the data provided to the processor over a bus 17. Each processor may have its own memory (not shown), which may be used for intermediate results, and may also have access to a shared memory 18, which may be used to store the software routines and updated metadata.

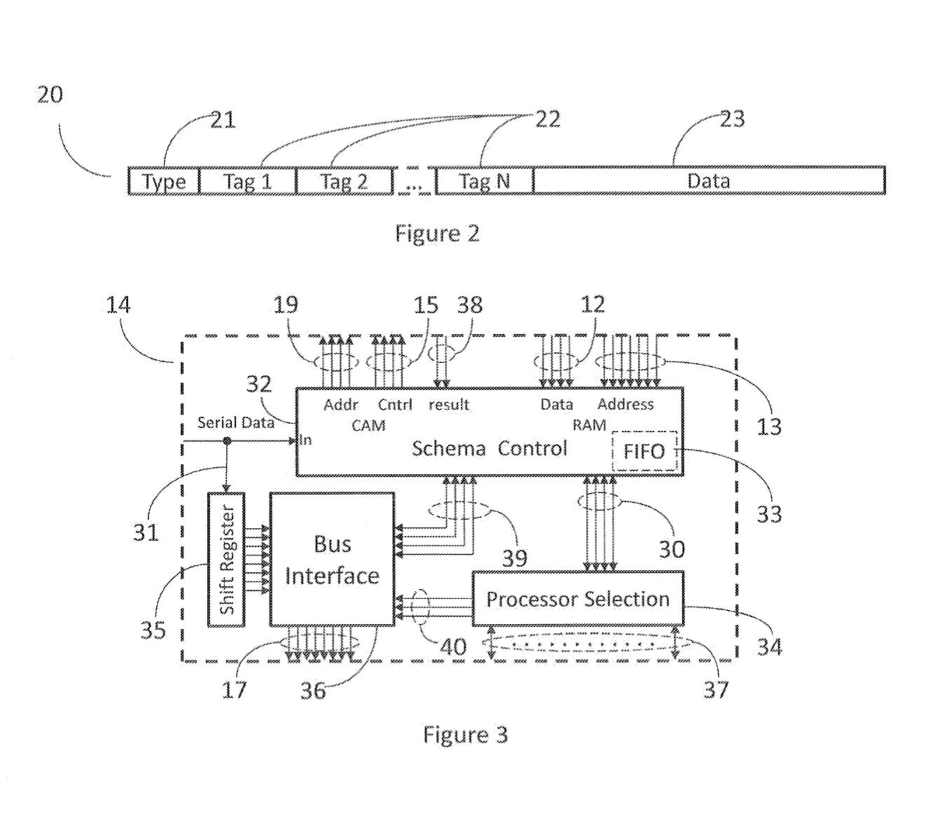

Reference is now made to FIG. 2, a simplified diagram of a data record that may be applicable to embodiments of the invention. Each data record 20 may contain a type code 21 for distinguishing between data records with different formats, or selection criteria, a plurality of tag fields 22, which may be used to select metadata processing, and a data field 23, which may be sent through the scheduler for subsequent processing.

Reference is now made to FIG. 3, a more detailed diagram of an embodiment of the scheduler 14 in FIG. 1. The serial data 31 may serially transfer data records through the serial CAM into the scheduler's 14 shift register 35 and the Schema Control 32. The Schema Control 32 may then use the data record's type code to select a sequence of addresses 19, which may be circular addresses, and CAM control signals 15, where addresses 19 and CAM control signals 15 may be used to control what type of comparison may be done by the serial CAM. Alternatively, if no type code exists, the Schema Control 32 may use a default sequence of addresses 19 and CAM control signals 15. Any number of data record tags 22, e.g., as shown in FIG. 2, may be compared with the contents of the CAM using greater than, less than and/or equal operations. The result signals may indicate if the parameters 12 and software routine addresses 13 are available for depositing in the memory (shown as a FIFO memory 33) within the Schema Control 32. There may be multiple, one, or no lines of such information from the RAM 11 corresponding to the number of comparisons from the serial CAM 10. Thereafter, when the rest of the data record has been shifted into the shift register 35, the Schema Control 32 may apply control signals 15 to the CAM to load some or all of the data record into the CAM, and request a processor from Processor Selection 34 via the processor request-acknowledge lines 30. The Processor Selection 34 may also be coupled to all the processors via processor signals 37 and the Bus Interface 36 via processor address lines 40. When, upon a request for a processor from the Schema Control 32, a processor is determined to be available from the processor signals 37, the Processor Selection 34 may: a) notify the selected processor to wake up, b) acknowledge to the Schema Control 32 that a processor is available, and c) send the processor address to the Bus Interface 36. Thereafter, the Schema Control 32 may transfer one or more stored lines from its FIFO 33 to the Bus Interface 36 via control and data lines 39. The control lines may instruct the Bus Interface 36 to further send the data, and possibly the data record, from the shift register 35 on the external bus 17 to the processor specified by the processor address lines 40.

Reference is again made to FIG. 1. Upon being awakened by the Scheduler 14, the selected processor 16 may perform a read of the bus 17, receive the parameters and address of a software routine, and branch to the address, and may receive the rest of the records sent by the scheduler. The software routine may then be used by the processor to process the records and update the appropriate metadata residing in the Memory 18. One or more of the processors 16 may have I/O capability (not shown) to read and/or write metadata or other data to external peripherals, which may include a network, as needed. It is also contemplated that this system may be used in conjunction with or separate from other backup or storage area network/network-attached storage (SAN/NAS) systems.

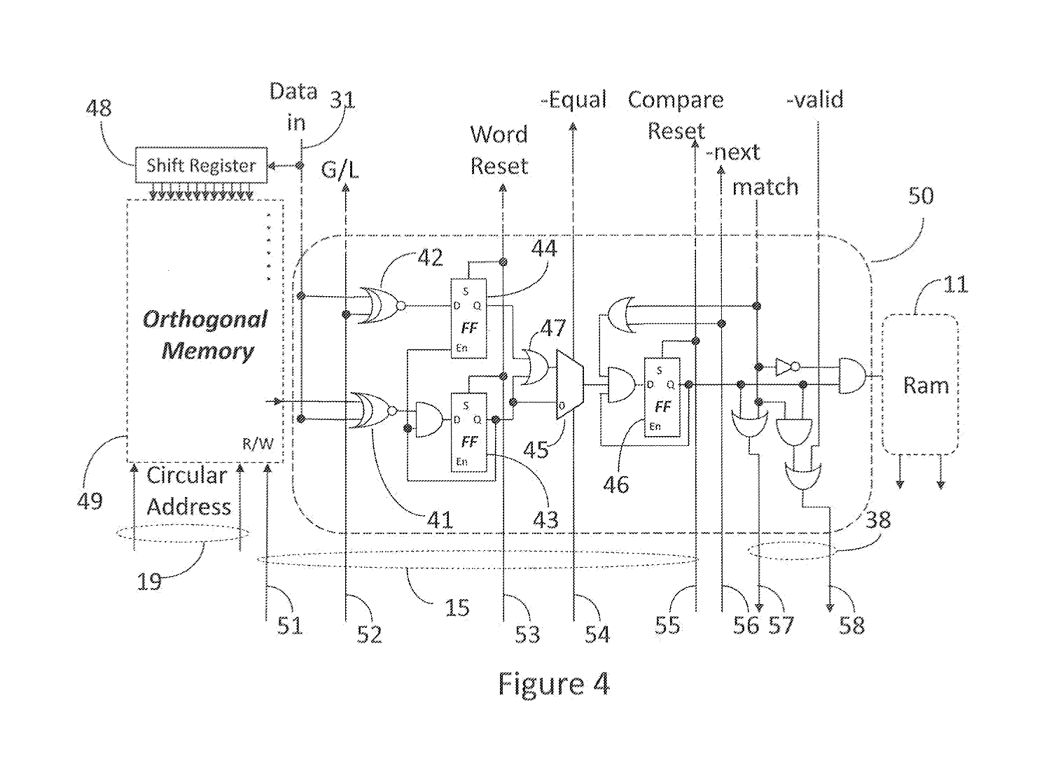

Reference is now made to FIG. 4, a diagram of a slice of the serial CAM 10, according to an embodiment of the invention. The logic 50 may be repeated for each word output from the Orthogonal Memory 49. Prior to performing a compare, the Flip-Flops 43,44 and 46 may be set high by setting the Word Reset 53 and the Compare Reset 55 high for one clock cycle. The circular address 19 may then be set to address the comparison data in the orthogonal memory 49, and the control signals 15 may be set to perform the proper compare operation. The bits of a tag field may then be serially entered, one bit per clock cycle, on the Data In 31 line and into the Shift Register 48, as the circular address 19 selects a corresponding bit from the Orthogonal Memory 49, for each word, to compare in the XNOR gate 41. Upon the first unequal compare, the XNOR gate 41 sets the compare flip-flop 43 low, which in turn disables the Greater/Less flip flop 44, on the next clock cycle, locking in the state determined by the compare of the G/L line 52 and the Data In 31 in the XNOR gate 42. If, in the first unequal compare, the Data In 31 is high, the Data In 31 value is greater than the word in memory. Conversely, if the Data In 31 is low, the Data In 31 value is less than the word in memory. As such, the G/L line 52 may be set high for a greater function and low for a less function. The OR gate 47 may be used to combine the equal signal and G/L functions together such that the resulting function is either “greater than or equal to” or “less than or equal to” (≧ or ≦). The equal portion of these functions may be useful to ensure a proper match result in the Match Flip-flop 46. The—Equal signal 54 may then cause the multiplexor 45 to select between this G/L function (output of OR gate 47) and just an equal function (=; output of flip-flop 45). Upon completion of the comparison, the Match Flip-flop 46 may be set high for all the words that met the function applied. Multiple words may be compared by setting just the Word Reset 53 high. Upon completion of all compares, there may be multiple Match Flip-flops 46 set high, which may be indicated by a high Match signal 57 and a high-valid signal 58, but only the first Match Flip-flop 46 that is set high may be used to address the RAM 11. By setting the—next signal 57 low, the first high Match Flip-flop 46 may be set low, allowing each high Match Flip-flop 46 to address the RAM 11 on successive clock cycles until the Match signal 57 goes low.

Upon completion of a compare, by setting the R/W signal 51 high, a portion or all of the data record serially shifted into the shift register 48 may be written into the Orthogonal Memory 49. In this fashion, new tag combinations may be anticipated and added to the CAM as needed. It should be understood that in one embodiment of the Content Addressable Processing System, the shift register 48 may be the same as the shift register 35 shown in FIG. 3.

It is further contemplated, though not shown, that the corresponding line of the RAM 11 may be updated to link the new record to an existing or new software routine and that the Orthogonal Memory 49 may be cleared of some or all its contents.

Reference is again made to FIG. 1. It is also contemplated that the contents of the memory 18 and other memories embedded in the Scheduler 14 and processors 16 may be modified independent of normal data record processing. Conversely, it is also contemplated that a data record may contain sequences of circular addresses 19 and CAM control signals 15 with a record type that may cause the Schema Control 32 to load or replace sequences of circular addresses and CAM control signals for later use. Similarly, it is contemplated that a data record may contain a software routine comprised of sequences of software instructions, which the scheduler may transfer to the memory 18 while updating the RAM 11 with the location of the software routine to be accessed by a subsequent CAM comparisons.

It is also contemplated that a traditional CAM with parallel input data may also be used in place of a serial CAM described above.

It will be appreciated by persons skilled in the art that the present invention is not limited by what has been particularly shown and described hereinabove. Rather the scope of the present invention includes both combinations and sub-combinations of various features described hereinabove as well as modifications and variations which would occur to persons skilled in the art upon reading the foregoing description and which are not in the prior art.

I claim:

1. A digital system comprising:
a serial content-addressable memory (CAM);
a first memory;
a second memory;
a plurality of processors; and
a scheduler configured to repeatedly obtain one or more addresses of one or more software routines residing in the second memory and one or more associated parameters from the first memory, selected by results of comparisons performed by the serial CAM, and to transfer at least one address of the one or more software routines to an available processor selected from the plurality of processors.

2. The digital system as in claim 1, wherein the serial CAM is configured to perform comparisons including greater than or equal (≧), less than or equal (≦), and equal (=) between a serially inputted data record and data stored in the serial CAM.

3. The digital system as in claim 2, wherein said comparisons are performed between tag fields of the serially inputted data record and the data stored in the serial CAM according to a type code within the serially inputted data record.

4. A serial content-addressable memory (CAM) comprising:
a serial input;
a memory; and
comparison logic, wherein the comparison logic is configured to enable the serial CAM to compare, in parallel, a single bit of a data record received serially on the serial input with multiple bits of the memory, and wherein the comparison logic is further configured to implement two or more comparison functions selected from the group consisting of greater than or equal (≧), less than or equal (≦), and equal (=) comparison functions.

5. A method for processing data records, the method including:
a. using a type field of an input data record to select a schema control process for processing the data record;
b. comparing one or more tag fields of the data record with contents of a serial content-addressable memory (CAM) according to the selected schema control process; and
c. performing at least one of: selecting a schema control process for updating the serial CAM, based at least in part on one or more results of said comparing; forwarding one or more results of said comparing to a selected available processor for processing; and forwarding at least a portion of the data record to a selected available processor for processing.

6. The method as in claim 5, further comprising serially receiving at least the type field of the data record.

7. The method as in claim 5, wherein the memory comprises a first-in-first-out (FIFO) memory.

8. The method as in claim 5, wherein the one or more results of said comparing include an address of a software routine for processing the data record.

9. The method as in claim 5, further comprising inputting the rest of the data record by shifting the rest of the data record into a shift register.

10. The method as in claim 9, wherein updating the serial CAM includes transferring the at least part of the contents of the shift register into a memory of the serial CAM.

11. The method as in claim 9, wherein forwarding the data record to a selected available processor includes transferring at least part of the contents of the shift register onto a bus coupled to the processor.
